(19) United States
(12) Patent Application Publication
(10) Pub. No.: US 2011/0108648 A1
(43) Pub. Date: May 12, 2011

(54) Feeder For Material Shredder

(75) Inventor: Roy Woolcock, Wiltshire (GB)

(73) Assignee: Hammermills International, LLC

(21) Appl. No.: 12/939,318

(22) Filed: Nov. 4, 2010

Related U.S. Application Data
(60) Provisional application No. 61/258,882, filed on Nov. 6, 2009.

(51) Int. Cl. B02C 19/00

(52) U.S. Cl. 241/101.5; 241/285.1

(57) ABSTRACT

A feeder device for reducing the size of unshredded scrap material prior to entering a shredder to permit a reduction in size of the shredder and reduction in required power needed for shredding. The feeder device includes a vertically-declining feed chute having a receiving end for receiving scrap material and a depositing end for depositing scrap material, the receiving end having a greater width. The feed chute has a compactor plate and may have multiple compactor plates each movable by a controlled actuator and located between the receiving end and the depositing end. The compactor plate lateral moves in an arcuate manner traverse to a longitudinal axis of the feed chute for compacting scrap material. Subsequent the feed chute, at least one powered rotating drum vertically compacts the material, the material then entering a shredding chamber where a shredding rotor shreds the material, the material generally being comprised of metal.

### CROSS REFERENCE TO RELATED APPLICATIONS

I hereby claim benefit under Title 35, United States Code, Section 119(e) of U.S. provisional patent application Ser. No. 61/258,882 filed Nov. 06, 2009. The 61/258,882 application is currently pending. The 61/258,882 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a reducing unit and more specifically it relates to a feeder for material shredder for efficiently reducing the size of unshredded scrap metal prior to entering the shredder to permit a reduction in size of the shredder needed and reduction in necessary power required to shred the scrap metal.

2. Description of the Related Art

Any discussion of the related art throughout the specification should in no way be considered as an admission that such related art is widely known or forms part of common general knowledge in the field.

Various machines are available for reducing the size of scrap metal from automobiles, appliances, etc., such as by shredding the scrap metal. In addition to the possibility of reusing the scrap metal more easily once shredded, the scrap metal is much more easily disposed of when shredded or substantially reduced in size.

When desiring to shred large pieces of scrap metal, it is generally required to utilize a larger shredding machine, such as a shredding machine having a large entrance opening to accommodate for the large pieces of scrap metal. However, the cost associated with large shredders can often times be great and thus not economically feasible for many individuals and/or businesses. For this reason, large pieces of scrap metal are often manually cut, such as via a torch or other cutting mechanism, prior to being loaded within the shredder; however handling and manipulating large pieces of scrap metal either manually or through the use of machinery can be a tedious, expensive, and difficult process.

Because of the inherent problems with the related art, there is a need for a new and improved feeder for material shredder for efficiently reducing the size of unshredded scrap metal prior to entering the shredder to permit a reduction in size of the shredder needed and reduction in necessary power required to shred the scrap metal.

### BRIEF SUMMARY OF THE INVENTION

A system for efficiently reducing the size of unshredded scrap metal prior to entering the shredder to permit a reduction in size of the shredder needed and reduction in necessary power required to shred the scrap metal. The invention generally relates to a reducing unit which includes a vertically-declining feed chute having a receiving end for receiving scrap material and a depositing end for depositing scrap material, the receiving end having a greater width. The feed chute has a compactor plate and may have multiple compactor plates each movable by a controlled actuator and located between the receiving end and the depositing end. The compactor plate lateral moves in an arcuate manner traverse to a longitudinal axis of the feed chute for compacting scrap material. Subsequent the feed chute, at least one powered rotating drum vertically compacts the material, the material then entering a shredding chamber where a shredding rotor shreds the material, the material generally being comprised of metal.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention used with a material shredder.

FIG. 2 is an upper perspective view of the feed chute and compactor plate.

FIG. 3 is a top view of the feed chute with the compactor plate in an open position.

FIG. 4 is a top view of the feed chute with the compactor plate in a closed position.

FIG. 5 is a top view of the feed chute having a compactor plate along each side.

FIG. 6 is a side view of the present invention used with a material shredder.

### DETAILED DESCRIPTION OF THE INVENTION

### A. Overview.

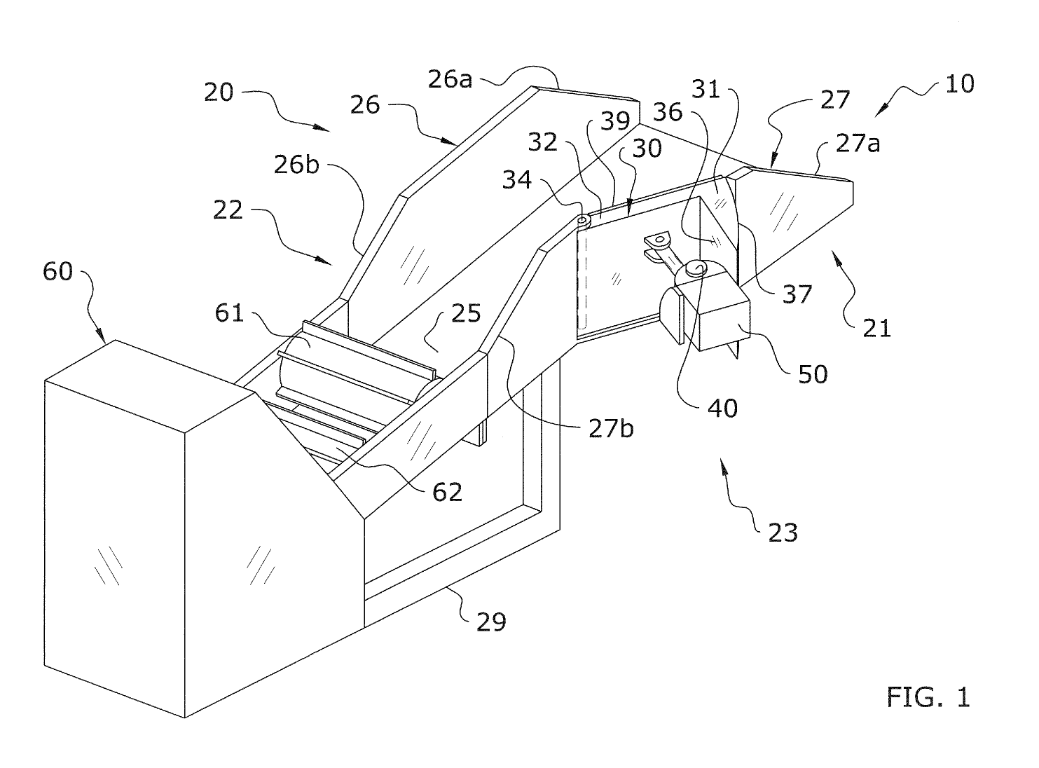

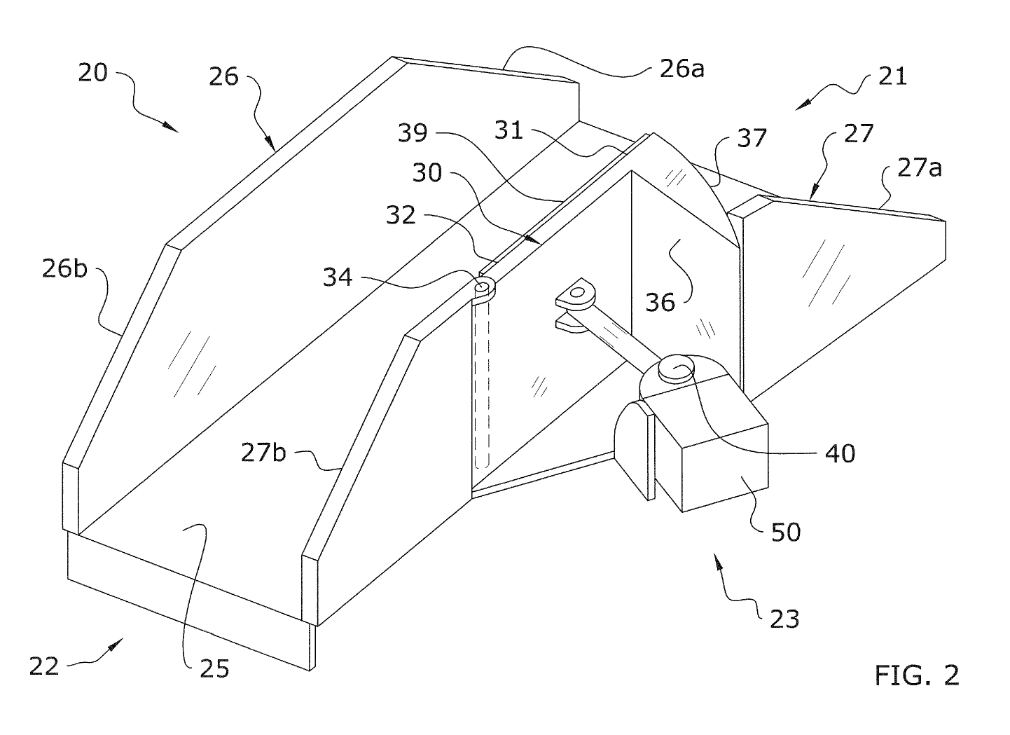

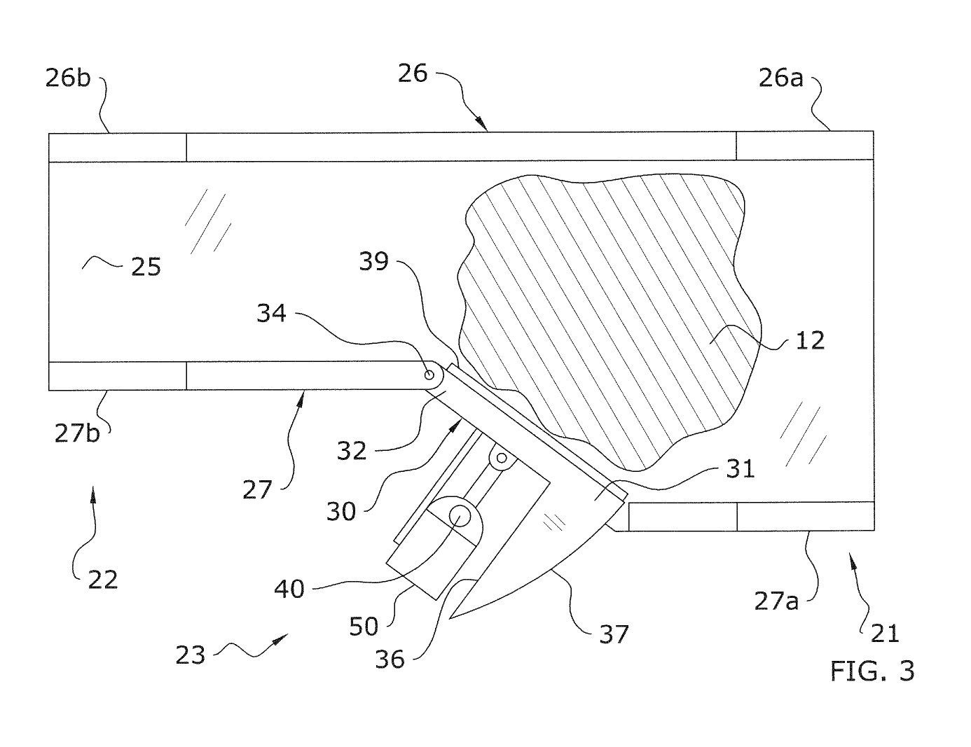

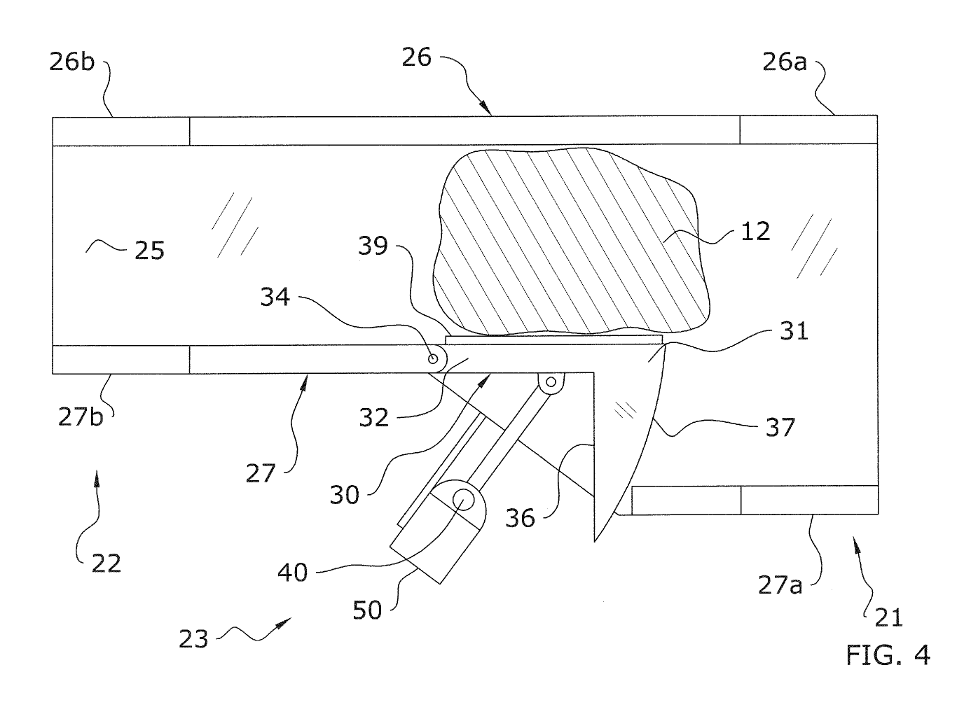

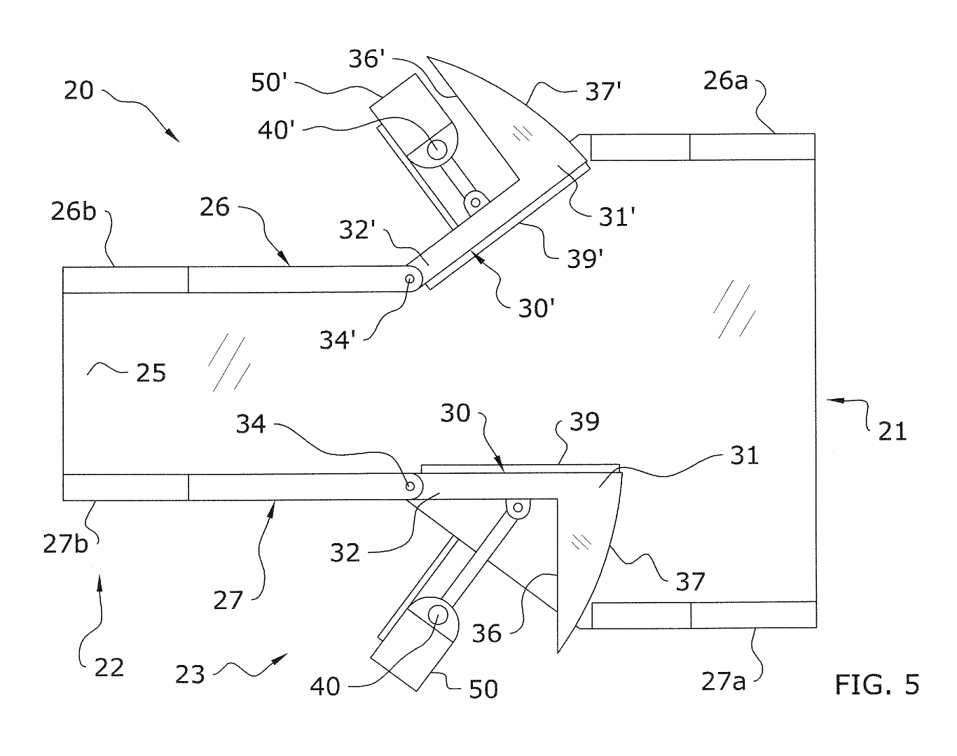

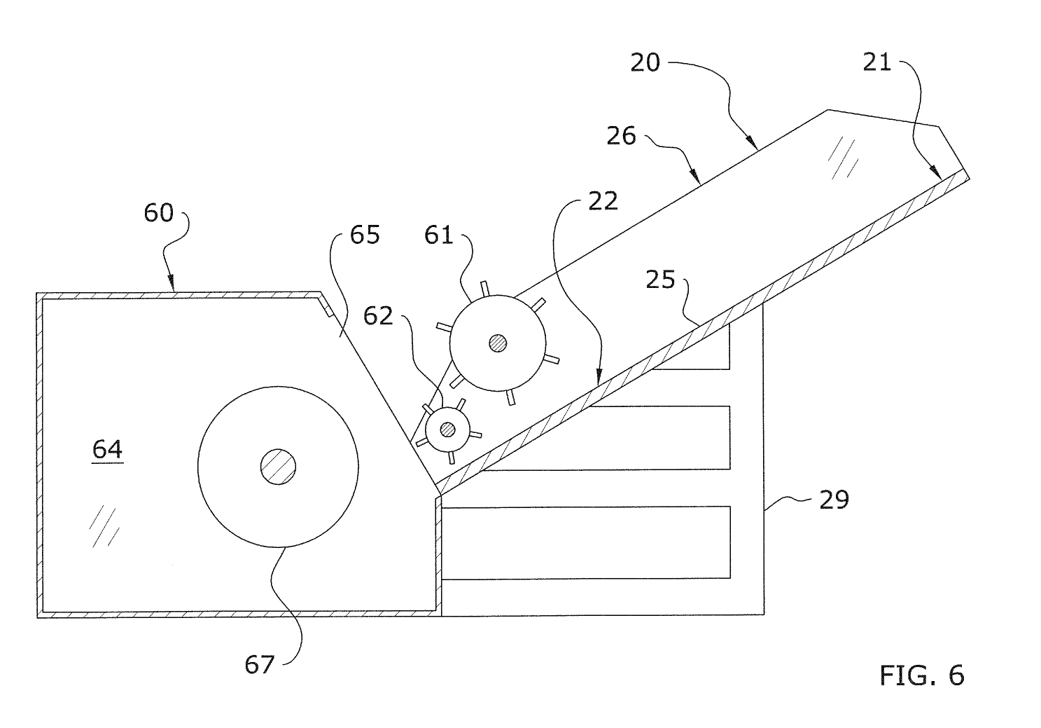

Turning now descriptively to the drawings, in which similar reference characters denote similar elements throughout the several views, FIGS. 1 through 6 illustrate a feeder for material shredder 10, which comprises a vertically-declining feed chute 20 having a receiving end 21 for receiving scrap material 12 and a depositing end 22 for depositing scrap material 12, the receiving end 21 having a greater width. The feed chute 20 has a compactor plate 30 and may have multiple compactor plates 30, 30′ each movable by a controlled actuator 40, 40′ and located between the receiving end 21 and the depositing end 22. The compactor plate 30 lateral moves in an arcuate manner traverse to a longitudinal axis of the feed chute 20 for compacting scrap material 12.

Subsequent the feed chute 20, at least one powered rotating drum 61, 62 vertically compacts the material 12, the material 12 then entering a shredding chamber 64 where a shredding rotor 67 shreds the material 12, the material generally being comprised of metal, such as from appliances, vehicles, etc. It is appreciated that if the second compactor plate 30′ and associated components are utilized they are generally identical to the first compactor plate 30 and associated components, thus in the description only the first compactor plate 30 will be focused upon; however it is appreciated that the first compactor plate 30 may be duplicated on the other side of the feed chute 20 if desired.

### B. Feed Chute.

The feed chute 20 is for directing the scrap material 12 towards the shredding chamber 64 and for compacting the scrap material 12 to a smaller size prior to entering the shredding chamber 64 to permit a reduction in size of the shredder 60 and reduction in required power needed for shredding, such as by allowing a reduction in the width of the rotating drums 61, 62 and/or shredding rotor 67. The feed chute 20 is generally angled vertically to decline towards the shredding chamber 64 thus allowing gravitational forces to assist in moving the scrap material 12 towards the shredding chamber 64. The feed chute 20 is generally supported by a framework 29, the framework 29 generally being adjustable to adjust the vertical angle of the feed chute 20 as desired or deemed necessary. Various adjustment mechanisms may be used with the framework 29 as appreciated.

The feed chute 20 generally comprises a receiving end 21 for receiving scrap material 12, a depositing end 22 for depositing the scrap material 12 to the rotating drums 61, 62 and/or the shredding chamber 64, and an intermediary portion 23 between thereof for compacting the scrap material 12 to a desired width and preferably the width of the depositing end 22. The receiving end 21 is wider than the depositing end 22 (generally by approximately 25 percent) to allow for the chute 20 to receive a larger piece of scrap material 12 than is ultimately delivered to the shredding chamber 64, thus allowing for a smaller shredding chamber 64. Between the receiving end 21 and the depositing end 22 is the intermediary portion 23 that is tapered along a side and employs a pivotal compactor plate 30 for compacting the scrap material 12 to fit between the sidewalls 26, 27b of the depositing end 22.

More particularly, the feed chute 20 has a flat platform 25 extending substantially linearly from the receiving end 21 to the depositing end 22, a first sidewall 26 also extending along a linear length of the feed chute 20 from the receiving end 21 to the depositing end 22, and a second sidewall 27 extending along a linear length of the feed chute 20 from the receiving end 21 to the depositing end 22, the second sidewall 27 being on an opposite side as the platform 25 as the first sidewall 26 and generally permitting free entry and exiting of the scrap material 12 from forward and rearward ends, while retaining the scrap material 12 upon the platform 25 with respect to opposing lateral sides, via the sidewalls 26, 27 extending substantially vertically upwards from the platform 25 along a longitudinal length of the platform 25.

The first sidewall 26 is generally continuous and comprised of a one piece structure, extending straight along the platform 25 from the receiving end 21 to the depositing end 22. The second sidewall 27 generally includes a first end portion 27a along the receiving end 21, a compactor plate 30 along the intermediary portion 23, and a second end portion 27b along the depositing portion. Each of the first sidewall 26 and the second sidewall 27 may include supporting framework or structure as needed for proper supporting and compacting structural properties.

The first end portion 27a of the second sidewall 27 is generally parallel with the first sidewall 26 and the second end portion 27b of the second sidewall 27 is also generally parallel with the first sidewall 26, the first end portion 27a being laterally or horizontally offset to the second end portion 27b with respect to the first sidewall 26 thus forming the wider receiving end 21 and the narrower depositing end 22. The first end portion 27a and the second end portion 27b are generally comprised of similar lengths; however differing lengths may be appreciated.

The compactor plate 30 forms the sidewall portion between the first end portion 27a and the second end portion 27b and generally is of a similar height as the first end portion 27a and the second end portion 27b. The compactor plate 30 has a first end 31 adjacent the first end portion 27a and a second end 32 adjacent the second end portion 27b, the compactor plate 30 being pivotal along the second end 32, wherein the pivot axis 34 is generally vertical to permit the compactor plate 30 to swing in an arcuate manner partially across the platform 25 to compact scrap materials 12 between the compactor plate 30 and the first sidewall 26 directly across from the compactor plate 30. It is appreciated that the pivotal axis may be altered to allow for the compactor plate 30 to travel inwardly in other manners and paths.

The compactor plate 30 also has a retaining wall portion 36 extending from the first end 31 of the compactor plate 30 in a traverse manner. The retaining wall portion 36 is positioned exterior to the platform 25 by extending away from the platform 25 in a closed position of the compactor plate 30 and extends along and partially across the platform 25 in an open position of the compactor plate 30 to fill a gap formed between the first end 31 of the compactor plate 30 and the first end portion 27a. The retaining wall portion 36 generally has a curved outer face 37 that is directed towards the receiving end 21 in the open position of the compactor plate 30 which allows for the scrap material 12 to move more smoothly along the retaining wall portion 36 and to not become jammed between the retaining wall portion 36 and the end wall portion 27a. The length of the retaining wall portion 36 is generally similar or at least as long as the lateral distance that the first end 31 of the compactor plate 30 swings inwardly when moving from the closed position to the open position, which is the difference between the first width (i.e. length between the first end portion 27a and the first sidewall 26) and the second width (i.e. length between the second end portion 27b and the first sidewall 26).

The compactor plate 30 also generally includes an abrasive resistant liner 39 along an interior surface of the compactor plate 30 for engaging the scrap material 12 and to protect the compactor plate 30, minimize damage to the compactor plate 30, and lengthen a life of the compactor plate 30. Various types of abrasive resistant liners 39 may be utilized according to the particular type of scrap material 12 that is being compacted. The resistant liner 39 may also extend along the interior surface of the first sidewall 26 and end portions 27a, 27b of the second sidewall 27.

The compactor plate 30 allows for a smaller width shredding machine 60 to be utilized to shred over-width scrap material 12 (i.e. scrap material 12 that is wider than the entrance opening 65 to the shredding chamber 64 or than the shredding rotor 67, such as automobile bodies, etc.). Thus, the narrower width shredder 60 allows for less “across the face contact” to the shredding rotor 67, creating less electrical “spikes” due to shock loads encountered, thus the narrow rotor 67 has a significantly reduced power usage. Since the narrow opening shredding machine 60 is less expensive to build, a small amount of investment can be added to make the shredding rotor 67 a larger diameter, which coupled with a narrower width, allows for a higher inertia resulting in higher production at lower energy consumption.

When in the closed position, the compactor plate 30 is generally angled inwardly from the receiving end 21 to the depositing end 22, thus forming a tapered travel of the scrap material 12 along the platform 25 to smoothly guide and transition the travel of the scrap material 12 towards the narrower depositing end 22. However, in the closed position, the compactor plate 30 still maintains a continuous wall by abutting the inner end to the end of the first end portion 27a and abutting the second end 32 to the inner end of the second end portion 27b. In the closed position, the first end 31 of the compactor plate 30 generally is spaced a distance from the first sidewall 26 equal to the distance between the first end portion 27a and the first sidewall 26, and the second end 32 of the compactor plate 30 generally is spaced a distance from the first sidewall 26 equal to the distance between the second end portion 27b and the first sidewall 26.

When in the open position, the compactor plate 30 is pivoted inwards to be generally flush with the second end portion 27b thus being spaced inwardly and thus laterally offset to the first end portion 27a with respect to the first sidewall 26. The first end 31 of the compactor plate 30 moves inwardly to compact the scrap material 12 between the compactor plate 30 and the first sidewall 26. The retaining wall portion 36, being fixed to the exterior surface of the compactor plate 30 adjacent the first end 31, moves inwardly also to fill the gap between the first end 31 and the first end portion 27a to ensure the scrap material 12 is retained upon the platform 25. In the open position, the first end 31 of the compactor plate 30 generally is spaced a distance from the first sidewall 26 equal to the distance between the second end portion 27b and the first sidewall 26, and similarly the second end 32 of the compactor plate 30 generally is spaced a distance from the first sidewall 26 equal to the distance between the second end portion 27b and the first sidewall 26.

In an alternate embodiment of the present invention, the first sidewall 26 may mimic a structure of the second sidewall 27, thus also having a first end portion 26a, a compactor plate 30′ having a first end 31′ and a second end 32′, and a second end portion 26b, each generally being identical to and mirroring the second sidewall 27. Thus, the alternate embodiment allows for an even greater distance between opposing sidewall portions 26a, 27a of the receiving end 21 to accommodate even larger pieces of sheet metal or scrap material 12 and the alternate embodiment employs two compactor plates 30, 30′ each moving towards each other in a synchronous or asynchronous manner generally via multiple actuators 40, 40′. The receiving end 21 in the alternate embodiment thus generally employs a platform 25 having a width approximately 50 percent greater than the width of the platform 25 at the depositing end 22. It is appreciated that the second compactor plate 30′ also includes a vertical pivot axis 34′ and retaining wall portion 36′ having a curved face 37′ similar to the first compactor plate 30. Additional guards, extended skirts, etc. may also be utilized with the feed chute 20.

### C. Actuator.

The actuator 40 is used to move the compactor plate 30 back and forth between the closed position and the open position. The actuator 40 is generally positioned on an exterior side of the compactor plate 30. The actuator 40 is generally comprised of a hydraulic cylinder type with a force of approximately 16 tons; however other types of actuating mechanisms may be utilized to swing the compactor plate 30 inwards and outwards, all which arc suitable for providing a sufficient force to compact the scrap material 12. The actuator 40 can be an isolated unit or can be attached to existing or other power units on other portions of the shredding machine 60. A second actuator 40′ may be used in the alternate embodiment for moving the second compactor plate 30′ in a similar manner.

### D. Controller.

The present invention includes at least one controller 50 for starting and stopping the actuator 40 to move the compactor plate 30 via sending a control input signal. The controller 50 may be manually activated, such as by manually viewing the position of the scrap material 12 in the feed chute 20 to determine when the scrap material 12 should be compacted or may be automatically activated via various sensors, etc. when a proper position of the scrap material 12 within the feed chute 20 is detected. The controller 50 is generally located external to the feed chute 20 to prevent engagement with the scrap material 12. The controller 50 may also include various types of interfaces.

### E. Shredding Machine.

Various types of shredding machines may be utilized at the end of the feed chute 20 for receiving the compacted scrap material 12. Among other components, the shredding machine 60 typically includes a rotating drum(s) 61, 62, a shredding chamber 64, and a shredding rotor 67.

The depositing end 22 of the feed chute 20 preferably leads to at least one powered rotating drum 61 for vertically compaction of the scrap material 12 and feeding of the scrap material 12 within the shredding chamber 64 via paddles, etc. It is appreciated that multiple vertically staggered rotating drums 61, 62 may be utilized and that the rotating drums 61, 62 may be comprised of various structures conventional in the prior art of compacting and shredding machines.

The shredding chamber 64 is fed the compacted scrap material 12 from the rotating drum 61 and generally includes an entrance opening 65 that is sized to receive the compacted scrap material 12, wherein the size of the entrance opening 65 may be substantially smaller than the original size of the scrap material 12 due to the compacting process of the compactor plate 30. The shredding chamber 64 may be comprised of various structures conventional in the prior art of shredding machines.

The shredding rotor 67 is positioned within the shredding chamber 64 and is fed the compacted scrap material 12. The shredding rotor 67 may be comprised of various structures conventional in the prior art of shredding machines.

### F. Operation of Preferred Embodiment.

In use, over-width scrap material 12 is fed into the receiving end 21 of the feed chute 20, which is approximately 25 percent larger than the depositing end 22 and shredder chamber entrance opening 65. Once the scrap material 12 moves to the intermediary portion 23 of the feed chute 20, the operator can activate the compacting operation, either manually, or with optional sensors. The hinged compactor plate 30 travels in an arc, via the actuator 40 applying a massive force, to compress the scrap material 12 to a width sufficiently narrower to enter the depositing end 22 of the chute 20 and entrance opening 65 of the shredder chamber 64. At the end of the opening stroke of the actuator 40, the actuator 40 would automatically retract to the closed position.

If the over-width scrap material 12 is longer than the length of the compactor plate 30, the compacting sequence can be repeated until the over-width scrap material 12 has been digested by the shredding machine 60. The in-feed scrap material 12 generally has very little elastic properties and thus will retain its compressed shape formed by the compactor plate 30. The compactor plate 30 is preferably able to squeeze scrap material 12 from a width of approximately 80″ to a width of approximately 60″; however other widths may be appreciated.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. In case of conflict, the present specification, including definitions, will control. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. A feeder device for compacting and feeding materials to a material shredder, said feeder device comprising:
a feed chute having a receiver end for receiving scrap material and a depositing end for depositing compacted scrap material into a material shredder,
wherein said receiver end has sidewalls defining a first width between thereof and wherein said depositing end has sidewalls defining a second width between thereof, said first width being greater than said second width;
wherein said chute has an intermediary portion between said receiver end and said depositing end, said intermediary portion having a pivotal compactor plate defining a first sidewall of said intermediary portion and having a first end and a second end, said pivotal axis along said second end;
an actuator means connected to said compactor plate for pivotally moving said compactor plate to an open position and a closed position;
wherein said first end is continual with said sidewall of said receiver end and said second end is continual with said sidewall of said depositing end so that said compactor plate angles inwardly from said receiver end to said depositing end in said closed position;
wherein said first end is spaced-inwardly from said sidewall of said receiver end and said second end is flush with said sidewall of said depositing end in said open position so that a width between said compactor plate and an opposing second sidewall of said intermediary portion equals said second width.

2. The feeder device of claim 1, wherein said sidewalls of said receiver end are parallel to said sidewalls of said depositing end.

3. The feeder device of claim 2, wherein at least one of said sidewalls of said receiver end is flush with at least one of said sidewalls of said depositing end.

4. The feeder device of claim 3, wherein said opposing sidewall of said intermediary portion is flush with said flush sidewalls of said receiver end and said depositing end.

5. The feeder device of claim 1, wherein said chute is vertically angled, said receiver end being higher than said depositing end.

6. The feeder device of claim 1, wherein said actuator means is comprised of at least one hydraulic cylinder.

7. The feeder device of claim 1, wherein said actuator means moves said compactor plate in an arcuate manner.

8. The feeder device of claim 1, including a controller to control said actuator means.

9. The feeder device of claim 1, wherein said chute includes a platform continually extending in a linear manner from said receiving end, to said intermediary portion, to said depositing end.

10. The feeder device of claim 1, wherein said compactor plate has an abrasive resistant liner along an interior surface.

11. The feeder device of claim 1, wherein said compactor plate has a retaining wall extending from said first end in a traverse manner, said retaining wall restricting passage between said first end and an adjacent said sidewall of said receiving end when said compactor plate is in said open position.

12. The feeder device of claim 11, wherein said retaining wall is curved.

13. A metal shredding system, comprising:
a feed chute;
wherein said feed chute vertically declines;
wherein said feed chute has a receiving end for receiving scrap metal and a depositing end for depositing scrap metal, said receiving end having a greater width than said depositing end;
wherein said feed chute has a first compactor plate, said first compactor plate being located between said receiving end and said depositing end, said first compactor plate adapted for lateral movement traverse to a longitudinal axis of said feed chute for compacting scrap metal;
at least one powered rotating drum adjacent said depositing end;
a shredding chamber adjacent said at least one powered rotating drum; and
a shredding rotor located within said shredding chamber for shredding compacted scrap metal.

14. The metal shredding system of claim 13, including a second compactor plate located upon an opposite sidewall of said feed chute as said first compactor plate.

15. The feeder for metal shredder of claim 14, wherein said second compactor plate is directly across from said first compactor plate with respect to said longitudinal axis of said feed chute.

16. The feeder for metal shredder of claim 15, wherein said first compactor plate and said second compactor plate each move in an arcuate manner.

17. The feeder for metal shredder of claim 16, including a first actuator for moving said first compactor plate and a second actuator for moving said second compactor plate.

18. The feeder device of claim 17, including a controller to control said first actuator and said second actuator.

19. The feeder device of claim 13, wherein said first compactor plate has a retaining wall extending from said first end in a traverse manner, said retaining wall restricting passage between said first compactor plate and an adjacent sidewall of said receiving end when said first compactor plate is in an open position.

20. A feeder device for compacting and feeding materials to a metal shredder, said feeder device comprising:
a feed chute having a platform, a first sidewall, and a second sidewall;
wherein said first sidewall is straight;
wherein aid second sidewall has a first end portion, a compactor plate, and a second end portion, said first end portion being parallel to said first sidewall and said second end portion being parallel to said first sidewall;
wherein said first end portion is laterally offset to said second end portion with respect to said first sidewall;
wherein a first distance across said platform between said first end portion and said first sidewall is greater than a second distance across said platform between said second end portion to said first sidewall, said first distance being greater than said second distance by approximately 25 percent;
wherein said compactor plate of said second sidewall is pivotal, said compactor plate adapted to move from a closed position to an open position;
wherein said compactor plate is angled in said closed position to connect laterally offset first end portion and said compactor plate forming a continuous second sidewall;
wherein said compactor plate is flush with said second end portion in said open position and wherein said compactor plate is laterally spaced from said first end portion in said open position;
wherein said compactor plate includes a retaining portion extending laterally outward from said compactor plate adjacent said first end portion;
wherein said retaining portion closes a gap formed between said compactor plate and said first end portion in said open position of said compactor plate;
wherein said retaining portion is curved;
wherein said compactor plate moves in an arcuate manner from said closed position to said open position; and
an actuator means connected to said compactor plate for moving said compactor plate between said closed position and said open position; and
a controller means for controlling said actuator means.
